(19) United States
(12) Patent Application Publication
(10) Pub. No.: US 2025/0060164 A1
(43) Pub. Date: Feb. 20, 2025

(54) INDIRECT CALCINATION METHOD

(71) Applicant: Industrial Accessories Company, Overland Park, KS (US)

(72) Inventor: Michael A. Jones, Gillette, WY (US)

(21) Appl. No.: 18/721,008

(22) PCT Filed: Dec. 22, 2022
(86) PCT No.: PCT/US2022/082298

§ 371 Date: Jun. 17, 2024

Related U.S. Application Data
(60) Provisional application No. 63/293,341, filed on Dec. 23, 2021.

(51) Int. Cl. F27B 7/10; C01B 32/05; C04B 7/36; C04B 7/44; F23K 3/00; F27B 7/20; F27B 7/34; F27D 17/00

(52) U.S. Cl. CPC F27B 7/10; C01B 32/05; C04B 7/367; C04B 7/4415; C04B 7/4492; F23K 3/00; F27B 7/2016; F27B 7/2075; F27B 7/34; F27D 17/004; F23K 2201/20; F27D 2017/005; F27M 2003/03

(57) ABSTRACT

Apparatus. methods. and systems for heat treatment of solid materials utilizing an indirect rotary calciner comprising one or more thermal expansion tolerant inner tubes fixed to an outer rotating shell. for example. by one or more resilient support members. The described methods of thermal treatment may be particularly utilized with cement and lime production processes and/or other heat treatment applications. such as pyrolysis.

### CROSS-REFERENCE TO RELATED APPLICATIONS

The present application claims the priority benefit of U.S. Provisional Patent Application Ser. No. 63/293,341, filed Dec. 23, 2021, entitled INDIRECT CALCINATION METHOD FOR CEMENT AND LIME PRODUCTION, incorporated by reference in its entirety herein.

### FIELD

The present disclosure generally relates to methods, systems, and apparatus for thermally treating solid materials. In particular, the methods and apparatuses may be useful in the calcination of carbonaceous materials for producing cement and lime products and/or for pyrolysis of organic materials.

### BACKGROUND

Various systems and equipment exist for heating and thermally treating solid materials. For example, cement and lime production pre-heat raw materials comprising calcium carbonate before introducing the pre-heated materials into a clinker kiln. Indirect rotary calciners for pre-heating raw materials generally utilize high-temperature alloy cylinders that can process material up to 1,100° C. A typical rotary indirectly heated calciner comprises a rotating cylinder housed within a stationary insulation-lined furnace.

Additionally, pyrolysis of consumer/industrial waste and organic matter is commonly used to break down and/or react the feed materials into useful solids, liquids, and gases. Such processes generally require heating the feed material to temperatures of at least 400° C. to 800° C., or even greater temperatures. There is a need for systems and methods for heat treating these feed materials that are thermally efficient and minimize the release of harmful by-products to the environment.

Worldwide increased awareness in the effects of unchecked carbon dioxide (CO2) production has led to the development of numerous methods and processes capable of capturing CO2 from industrial process flue gases and waste streams. The reduction of non-combustion derived CO2 emissions in cement plants and lime plants is of particular interest.

Many CO2 capture methods have been proposed. A significant portion of the current approaches to CO2 emissions reduction and capture have shown that CO2 sorbent regeneration cost accounts for roughly 70% of the total cost of CO2 capture. Other CO2 capture methods such as membrane technologies have also shown to be operationally expensive and are yet unproven with regards to economical long-term viability.

There is a need for a more effective CO2 capture methods having a much lower overall cost of for CO2 capture, as compared to other existing or emerging technologies. Accordingly, there has yet to be developed a large scale, low risk, and operationally economical method for CO2 capture that is capable of near-term widespread use.

The process integration of the indirect calcination process into a cement plant exists in the prior art literature. For example, Project LEILAC in the EU proposes a stationary shell vertical drop through indirect calciner for this application. Calcium looping strategies also revolve around indirect re-calcination of adsorbed CO2. Another hybrid concept was outlined in a paper titled “A Hybrid Carbon Capture System of Indirect Calcination and Amine Absorption for a Cement Plant” (Dursun Can Ozcan, Stefano Brandani, Hyungwoong Ahn et al./Energy Procedia 63 (2014) 6428-6439). This paper describes the process integration of the indirect calcination process existing in the literature into a cement plant.

However, each of the previously envisioned methods have yet to demonstrate the ability to scale to the size required for typical cement operations. Therefore, there remains a need for a unique indirect calciner capable of near order of magnitude increased capacity with robust operational capability and reliability.

### BRIEF SUMMARY

In one embodiment, there is provided an indirect rotary calciner comprising an elongated rotatable outer shell and one or more inner tubes residing within the outer shell. The one or more inner tubes are affixed to the outer shell such that the one or more inner tubes rotate upon rotation of the outer shell.

In one embodiment, there is provided an indirect rotary calciner comprising an elongated rotatable outer shell comprising a first end and a second end and configured to calcine a solid material passing therethrough, one or more inner tubes residing within the outer shell configured to flow a heating fluid therethrough to heat the solid material passing through the outer shell, and one or more support members interconnecting the rotatable outer shell and the one or more inner tubes.

In one embodiment, there is provided a method of calcinating a solid material. The method comprises providing an indirect rotary calciner comprising an elongated rotatable outer shell and one or more inner tubes residing within the outer shell affixed to the outer shell such that the one or more inner tubes rotate upon rotation of the outer shell. The method further comprises introducing the solid material into the indirect rotary calciner and producing a calcined raw material and a quantity of a volatilized substance, and recovering at least a portion of the quantity of volatilized substance produced in the indirect rotary calciner.

### BRIEF DESCRIPTION OF THE DRAWINGS

To ensure that the above recited features of the present disclosure can be more fully understood, additional aspects are disclosed using illustrations in the appended drawings. It is to be understood, however, that the appended drawings illustrate only general aspects of this present disclosure and are therefore not to be considered limiting of its scope. The present disclosure may contemplate, admit, or envision other equally effective aspects.

FIG. 1 is a schematic drawing of an indirect rotary calciner, according to an embodiment.

FIG. 2 is a cross-sectional schematic view of the calciner depicted in FIG. 1, showing radial heat transfer and rotation of the calciner.

FIG. 3 is a break away perspective view of an indirect rotary calciner, according to an embodiment.

FIG. 4 is a crosswise cross-sectional view of the calciner in FIG. 3.

FIG. 5 is a lengthwise cross-sectional view of the calciner in FIG. 3.

FIG. 6 is a close-up view of the view from FIG. 5.

FIG. 7 is a cross-sectional schematic view of an indirect rotary calciner including chains secured to the inner tube, according to an embodiment.

FIG. 8 is a side schematic view of the inner tube depicted in FIG. 7.

FIG. 9 is a schematic drawing of an indirect rotary calciner, according to an embodiment.

FIG. 10 is a schematic drawing of an indirect rotary calciner illustrating support methods, according to an embodiment.

FIG. 11 is a cross-sectional schematic view of the calciner depicted in FIG. 10.

FIG. 12 is partial schematic view of a calciner illustrating the discharge end configurations, according to an embodiment.

FIG. 13 is partial schematic view of a calciner illustrating the feed end, according to an embodiment.

FIG. 14 is a schematic drawing of an indirect rotary calciner illustrating multiple alloy calcining tube configurations of the disclosed indirect calciner, according to an embodiment.

FIG. 15 is a cross-sectional schematic view of the calciner depicted in FIG. 16.

FIG. 16 is a schematic drawing of an indirect rotary calciner illustrating multiple burner and waste heat configurations of the disclosed indirect calciner, according to an embodiment.

FIG. 17 is a block diagram illustrating a method for utilizing indirect calcination, according to an embodiment.

FIG. 18 is a schematic flow diagram illustrating a method for operating the disclosed method of indirect calcination, according to an embodiment.

Identical reference numerals have been used, where possible, to designate identical elements that are common to the figures. Figures are not drawn to scale and are simplified for clarity. It is to be understood that elements and features of one aspect may be beneficially incorporated in other aspects without further recitation.

### DETAILED DESCRIPTION

Embodiments of the present invention relate to apparatus, systems, and methods for thermal heat treatment of solid material. Exemplary heat treatments may be otherwise referred to as calcination, pyrolysis, or other thermal treatment or thermal decomposition process. Exemplary solid materials may include carbonaceous and non-carbonaceous materials and mixtures thereof. In certain embodiments, the solid material comprises a carbonaceous material. In certain embodiments, the carbonaceous material is selected from the group consisting of cement raw meal, carbonates (e.g., calcium carbonate, zinc carbonate, magnesium carbonate, lithium carbonate, etc.), consumer waste, industrial waste, plastics, organic materials, and mixtures thereof. In certain embodiments, the non-carbonaceous material is selected from the group consisting of alumina, bauxite, ceramics, clays, phosphates, silica, zeolites, and mixtures thereof. Embodiments of the present invention advantageously provide for more efficient thermal treatment and improved gas recovery compared to existing technologies, particularly at for large scale applications.

### Calciners

Embodiments of the present invention are directed to improved rotary indirectly heated calciners comprising, for example, a high-temperature inner cylinder fixed and supported within a rotating shell housing. The disclosed rotary indirectly heated calciners according to embodiments of the present invention may also be referred to as Supported Indirect Rotary Calciner (SIRC), and the terms such as SIRC, present invention, indirect rotary calciner, rotary indirectly heated calciner, and present disclosure may all be used interchangeably herein.

Indirect rotary calciners in accordance with embodiments of the present invention generally comprise an elongated rotatable outer shell and one or more inner tubes residing within the outer shell. The outer shell may be similar in design to conventional direct fired rotary kiln shells, although non-conventional features and components may be included, as described in herein. In certain embodiments, the elongated outer shell may have a generally cylindrical shape. In certain embodiments, the outer shell has an outer diameter of greater than about 5 meters, or about 5 meters to about 10 meters. Unlike conventional rotary kilns, one or more access doors may be formed in the outer shell, which can expedite inspection and repairs of the interior components. The outer shell may comprise a variety of materials. However, in certain embodiments, the outer shell comprises a carbon steel material. The outer shell can also be lined with various insulation material suitable for high temperature operation, as described below in greater detail. In certain embodiments, the outer shell can include a refractory liner to protect the outer shell from solid materials passing therethrough, such as carbonaceous feed material or ash/dust ladened waste heat sources.

The one or more inner tubes reside within the outer shell and are generally designed to provide indirect heat exchange with hot gaseous fluids to a solid material to be calcined. The one or more tubes may comprise a variety of geometries, such as those described in the embodiments below. In certain embodiments, each of the one or more inner tubes can extend at least the length of the outer shell. In certain embodiments, the one or more inner tubes are affixed to the outer shell such that the one or more inner tubes rotate upon rotation of the outer shell. In certain embodiments, the one or more inner tubes may comprise a metal alloy material and/or comprise a segmented, sleeved, or corrugated structure, which can provide a resiliency allowing the inner tube(s) to expand and contract, as described in greater detail below.

In certain embodiments, the SIRC comprises a fixed tube, or multiple fixed tubes, inside the rotatable outer shell. In such embodiments, both the outer housing chamber and inner tube chamber(s) are interconnected and rotate together. This feature provides numerous advantages. For example, this design allows for the ability to maximize the overall span and diameter of the SIRC without the excessive distortion and thermal creep limitations of conventional indirect calciners. The inner tube(s) can extend the entire length of the external shell, which is an improvement over existing indirect calciners. This can allow the inner tube(s) of the calciner to extend past riding support rings on the outer shell. As a result, the alignment of the inner calciner tube(s) is less critical in the present invention than in traditional calciners. The inner tube(s) can be concentrically located within the external shell, laterally disposed from the central axis of the external shell, or have a non-rectilinear configuration over at least a portion of the length of the inner calciner tube(s). Advantageously, the outer shell in the present invention may act as the main structural support for the entire length of the inner tubes. In such embodiments, this obviates the need for the extremely hot tube(s) to support their own structural loads across long spans. In certain embodiments, the one or more inner tube(s) can have a diameter of at least 2 meters, or at least 3 meters. In certain embodiments, the one or more inner tube(s) can have a length of at least 50 meters, or at least 60 meters.

Embodiments of the present invention may further incorporate design features to mitigate extreme thermal expansion differences between the inner tube(s) and the outer shell. These are particularly advantageous when the inner tube(s) are uninsulated and comprise a metal alloy material and/or the outer shell comprises carbon steel. The outer shell may further comprise an insulated interior wall that reduced heat loss from the outer shell. In one or more embodiments, the insulated interior wall may be lined with a refractory material. Expansion of an alloy tube may depend on the operating temperature and its overall length and diameter. In certain embodiments, it is possible for the tube to thermally expand over 1 meter in length, for example, on a 50-meter alloy tube. The ability to compensate for this thermal expansion with minimal overall differential movement has clear advantages over existing technologies. In certain preferred embodiments, the inner tube(s) comprise thermal expansion structure configured to accommodate thermal expansion of the inner tube(s). In one or more embodiments, the thermal expansion structure comprises a segmented alloy tube. In one or more embodiments, the thermal expansion structure comprises a bellows structure or a fully or partially corrugated alloy tube. These designs allow for the alloy tube to act as its own expansion joint to progressively compensate for the thermal expansion. Such a feature on a conventional self-supporting indirect calciner would not be feasible and would result in irreversible shell distortions and persistent misalignments. Other design options such as sleeved or telescoping alloy tubes can accomplish similar control of thermal expansion.

While reference is made herein to certain materials, such as metal alloys, it should be understood that the SIRC components, including the outer shell, inner tubes, and radial supports, may be made of other heat tolerant materials, including ceramics.

Exemplary embodiments of preferred and alternative SIRC configurations are described below. However, it will be appreciated that the various embodiments described herein are not necessarily mutually exclusive unless otherwise indicated. For example, a feature described or depicted in one embodiment may also be included in other embodiments, but is not necessarily included. Thus, the present invention encompasses a variety of combinations and/or integrations of the specific embodiments described herein.

It should be understood that the SIRC configurations in accordance with embodiments of the present invention may have a variety of sizes and geometries other than those expressly shown and described herein. Although the SIRC configurations shown in the figures are depicted as substantially horizontal, in certain embodiments, the SIRC may be installed with a tilted axis of elongation such the calcinated material is discharged from the lower end. In such embodiments, gravity can assist the flow of material through the SIRC and in the discharge of the heat-treated material from the SIRC.

### Preferred Embodiments

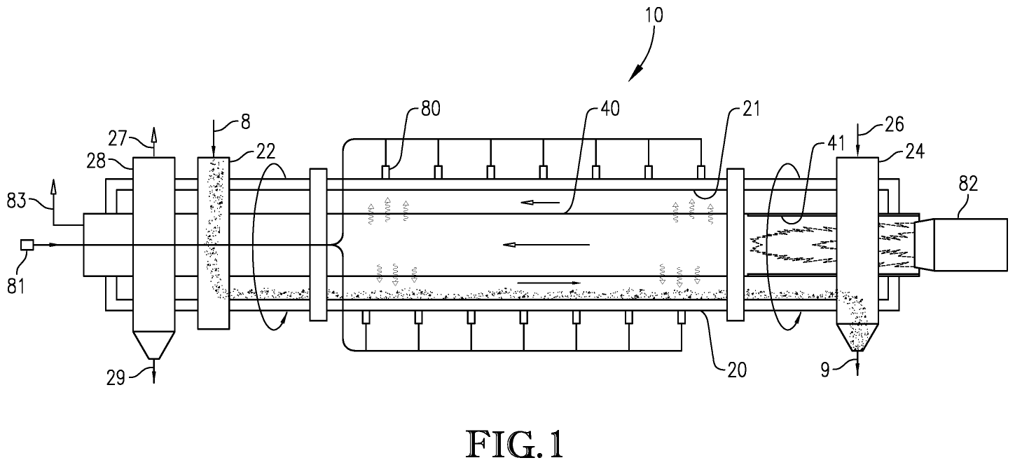

FIG. 1 to FIG. 8 illustrate an exemplary SIRC configuration and related indirect calcination processes according to embodiments of the present invention. It should be understood, however, that these configurations and processes are provided as examples only, and other indirect calciner configurations and processes may be used in accordance with embodiments of the present invention.

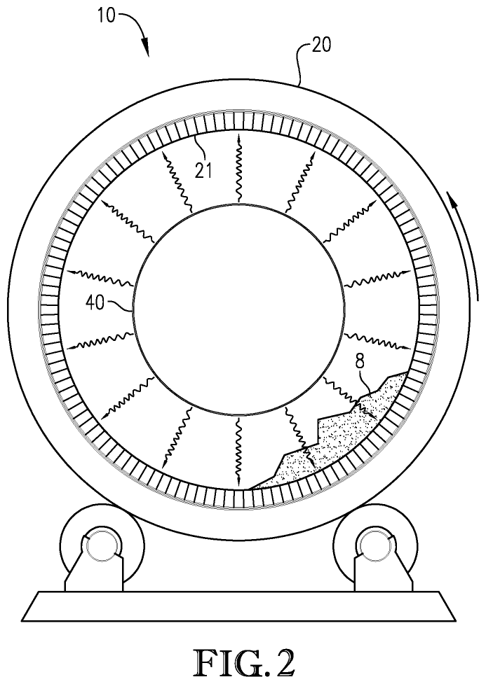

FIG. 1 depicts an exemplary indirect rotary calciner 10 and its corresponding operation. Generally, the solid material 8 to be thermally treated is introduced into the outer shell 20 (i.e., into the annular interstitial space between the outer shell 20 and the one or more inner tubes 40) and heated by indirect heat exchange with a heating fluid passing through the one or more inner tubes 40. The heating fluid in the one or more inner tubes provides for outward radiant heat transfer into the interstitial space, thereby providing the indirect heat transfer to the solid material 8 passing therethrough (See FIG. 2). This configuration, wherein the inner tubes 40 act to heat material flowing through the outer shell 20, can provide notable advantages over configurations where the heat-treated material flows through interior kiln tubes. First, the inner tubes 40 are less likely to be damaged or distorted during operations, since the inner tubes 40 are fully supported and not conveying solid material. Additionally, providing heat from the inner tubes 40 contained within outer shell 20 allows for more efficient radiant heat transfer from the inner tubes 40 to the solid material 8 flowing through outer shell 20, since less heat loss to the environment occurs.

In certain embodiments, solid material 8 comprises a carbonaceous material, as described above. In certain embodiments, solid material 8 comprises calcium carbonate (CaCO3). In certain embodiments, solid material 8 comprises a quantity of organic matter. In certain embodiments, solid material 8 may be pre-heated before being introduced into the calciner 10.

In certain embodiments, the solid material 8 may be injected or otherwise introduced into a feed collar 22 positioned at one end of the calciner 10. As solid material 8 passes through outer shell 20, solid material 8 is heated and calcined (or otherwise heat-treated, or pyrolyzed). The heat-treated solid material 8 may then be discharged 9 from calciner 10 via discharge collar 24. As noted above, outer shell 20 may comprise a refractory liner 21 or be otherwise insulated or protected from damage caused by heat and materials passing therethrough.

A purge fluid 26 may be introduced to discharge collar 24, which can facilitate the flow of CO2 and other gases in the outer shell 20 to flow toward a gas discharge collar 28. In certain embodiment, the purge fluid 26 comprises steam, although other fluids may also be used, such as natural gas, nitrogen, and/or compressed air. CO2, steam, and/or other gases introduced into the outer shell 20 or produced during the calcination can be discharged from collar 28 and recovered 27. Gas discharge collar 28 may also comprise a dust trap that can separate and recover solid particulates 29 entrained in the gas.

In certain embodiments, a plurality of gas injectors 80 may be affixed to the outer shell 20, which can continuously or periodically inject compressed air or other gas into the interstitial space to remove buildup of the solid material 8 and/or to facilitate the flow of the solid material 8 through the outer shell 20. As best illustrated in FIG. 1, the calciner 10 may utilize a plurality of injectors 80 oriented around the circumference of the outer shell 20. In certain embodiments, the plurality of gas injectors 80 comprise air cannons. A blower air/gas supply 81 may be included, which utilizes a blower or fan (not shown) with a radially configured air hood and manifold with branch air/gas lines feeding each injector 80. This option provides air/gas from a stationary blower to the rotating shell mounted injectors 80. In certain embodiments, about 20 to about 100 gas injectors are used, although even greater number of injectors may be used if necessary or desired.

In certain embodiments, the indirect calciner may operate such that the temperature in the space between the outer shell 20 and the one or more inner tubes 40 is at least about 400° C., at least about 600° C., at least about 700° C., or at least about 800° C. In certain embodiments, the indirect calciner may operate such that the temperature in the space between the outer shell 20 and the one or more inner tubes 40 is about 900° C. to about 1100° C., or about 1000° C. In certain embodiments, such temperatures are sufficient to pyrolyze a carbonaceous material, or can achieve nearly complete calcination of a CaCO3 fraction in a cement raw meal, or achieve nearly complete calcination of other carbonate materials.

In certain embodiments, a burner 82 can be located at one end of the one or more inner tubes 40 that provides heat to at least a portion of the heating fluid flowing through the one or more inner tubes 40. In certain such embodiments, at least a portion of the heating fluid may comprise the combustion gas produced by the burner 82. The used heating fluid may then be removed from calciner 10 as a flue gas 83 and optionally used for upstream pre-heating and/or pry-drying operations. The one or more inner tubes 40 may comprise a refractory liner 41 at least partially lining the interior surface of the tube(s) so as to limit the maximum tube temperature to inhibit or prevent warping or other damage to the tube(s).

Additionally, or alternatively, other hot fluids may be introduced to the one or more inner tubes 40 to provide at least a portion of the heating. For example, when solid material 8 comprises a feed material that is pyrolyzed in the outer shell 20, hot pyrolysis off-gas from the pyrolysis reaction can be introduced into the one or more inner tubes 40 as a heating fluid to provide at least a portion of the heating. In certain such embodiments, the off-gas may be at least partially thermally oxidized in the one or more inner tubes 40 to produce a treated waste gas stream. At least a portion of this treated waste gas stream may be recovered and used to pre-heat or pre-dry the feed material before introducing the material into calciner 10.

As shown, the flow of solid material 8 in outer shell 20 and the heat transfer fluid in inner tubes 40 may be counter-current. However, in certain embodiments, co-current flow can be utilized, for example, by changing the location of burner 82 to the opposite end of calciner 10.

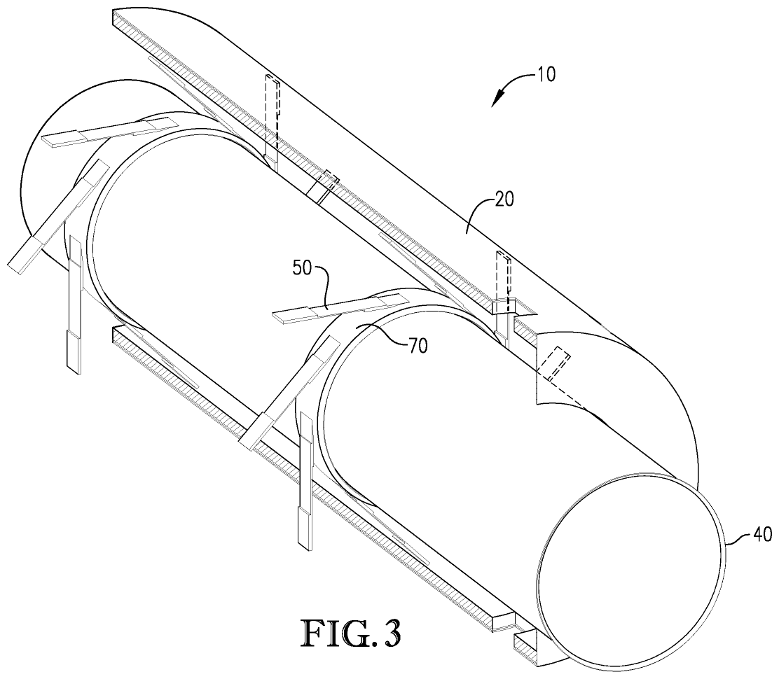

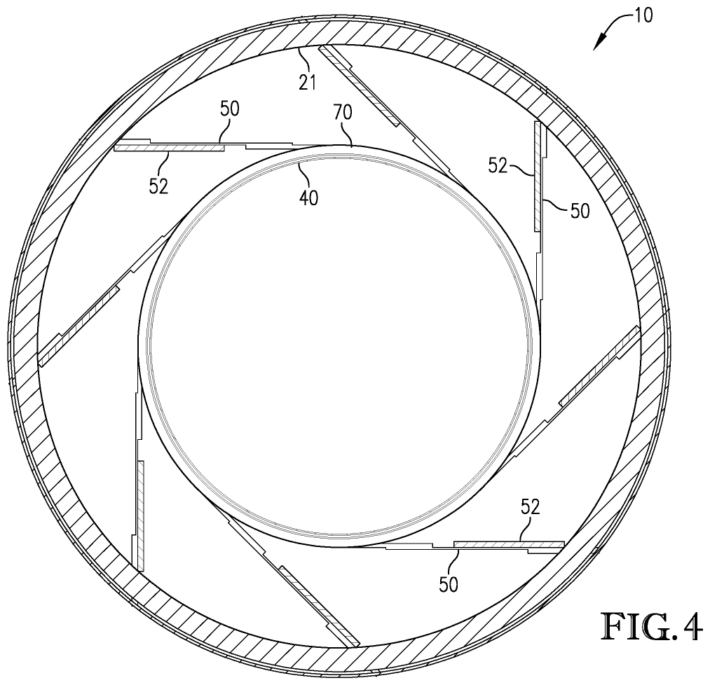

As best illustrated in FIG. 3 and FIG. 4, calciner 10 may comprise a plurality of resilient support members 50, each tangentially connected to the inner tube 40 and interconnecting the outer shell 20 and the inner tube 40. In certain embodiments, the support members 50 are secured to a support ring 70 encircling inner tube 40, thereby connecting the support members 50 to the inner tube 40. The resilient support members 50 can serve several functions. For example, the support members 50 interconnect the outer shell 40 and the inner tube 40 such that such that the inner tube 40 rotates upon rotation of the outer shell 20. Additionally, the plurality of support members 50 can be positioned so as to support the weight of inner tube 40 along the entirety of the length of outer shell 20, thereby minimizing distortion of inner tube 40 due to mechanical stresses. Moreover, the flexibility and angled (tangential) connection of the support members 50 to the inner tube 40 can compensate for thermal expansion differences between the inner tube 40, the support ring 70, and the outer shell 20. As the space between the outer shell 20 and the inner tube 40 is heated, the inner tube 40 and/or support ring 70 may thermally expand and, without design consideration, would impart stresses to the inner tube 40 potentially causing distortion and metal fatigue. The angled supports 50 allow for radial thermal expansion while still supporting the inner tube 40. The angled supports 50 also mitigate the diameter expansion of the inner tube 40 by flexing to the expanded diameter. In certain embodiments, the support members 50 may each comprise a protective liner 52 formed (e.g., welded or bolted) on at least a portion thereof configured to protect the support members 50 from damage by the solid material 8 passing through the outer shell 20. The supports 50 can be welded or bolted to the respective surfaces (i.e., outer shell 20, support ring 70). It will be understood that other design configurations for interconnecting inner tube 40 and outer shell 20 may also be used, such as those described in other embodiments herein or otherwise.

As described above, the plurality of support members 50 may be positioned along the length of the inner tube 40 so as to minimize the distortion of inner tube 40 due to mechanical stresses. In certain embodiments, the spacing of the plurality of support members 50 along the length of the inner tube 40 can be in intervals sufficient to inhibit or prevent permanent deformation of the inner tube 40 during regular operation of the calciner 10. In certain embodiments, the plurality of support members 50 may be longitudinally spaced along the length of the inner tube 40 in intervals having a distance of about 1 foot to about 30 feet, or about 5 feet to about 20 feet. When the support members 50 are secured to support rings 70, the support rings may also be longitudinally spaced along the length of the inner tube 40 in intervals having a distance of about 1 foot to about 30 feet, or about 5 feet to about 20 feet.

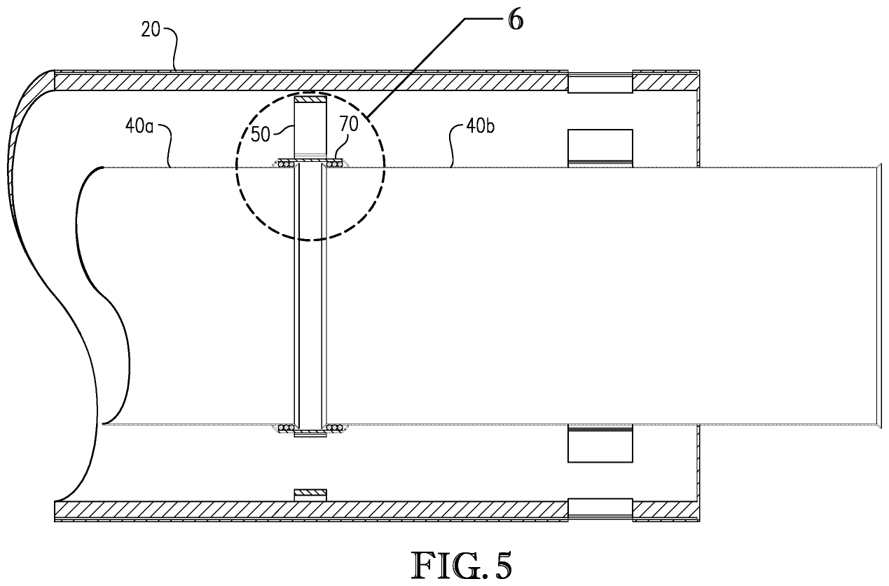

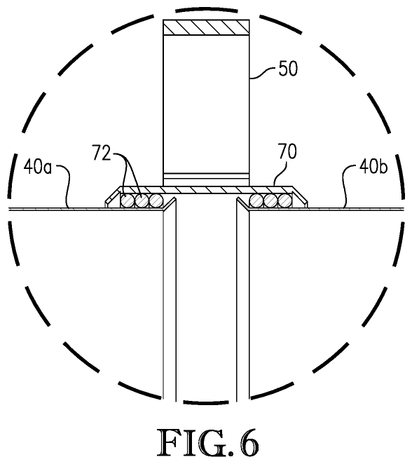

As shown in FIG. 5 and FIG. 6, in certain embodiments inner tube 40 may comprise at least two tube segments 40a, 40b connected by support ring 70 encircling, and thereby connecting, adjacent ends of the tube segments 40a, 40b. As best shown in FIG. 6, a seal 72 may be included between the exterior surfaces of tube segments 40a, 40b and the inner surface of the support ring 70, which can further accommodate thermal expansion of inner tube 40 and/or provide a gastight seal between the interior of inner tube 40 and the interstitial space between the inner tube 40 and outer shell 20. In certain embodiments, seal 72 may comprise a gasket, adhesive, and/or other resilient or gas impermeable material.

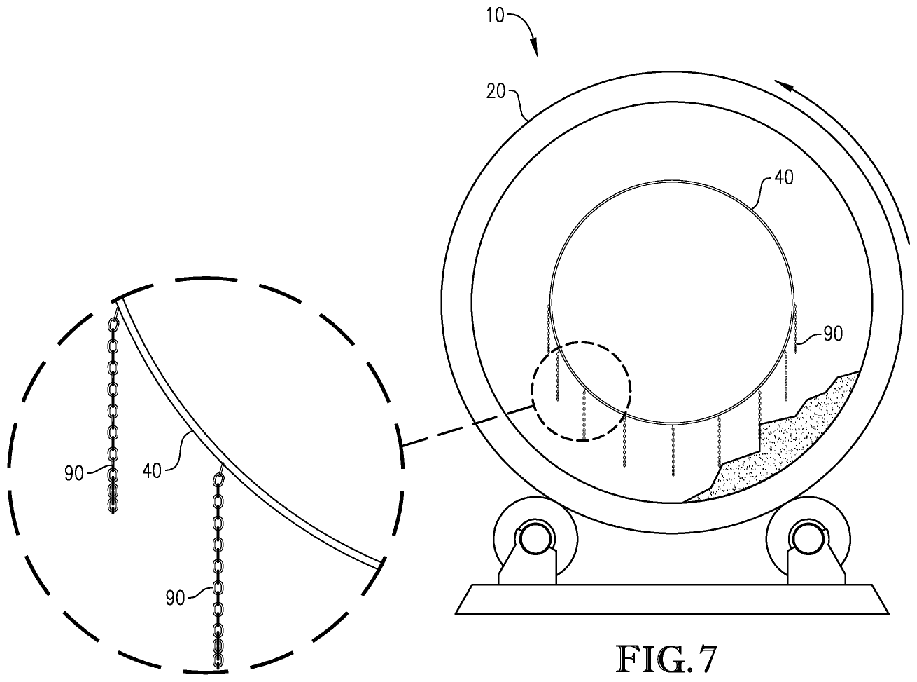

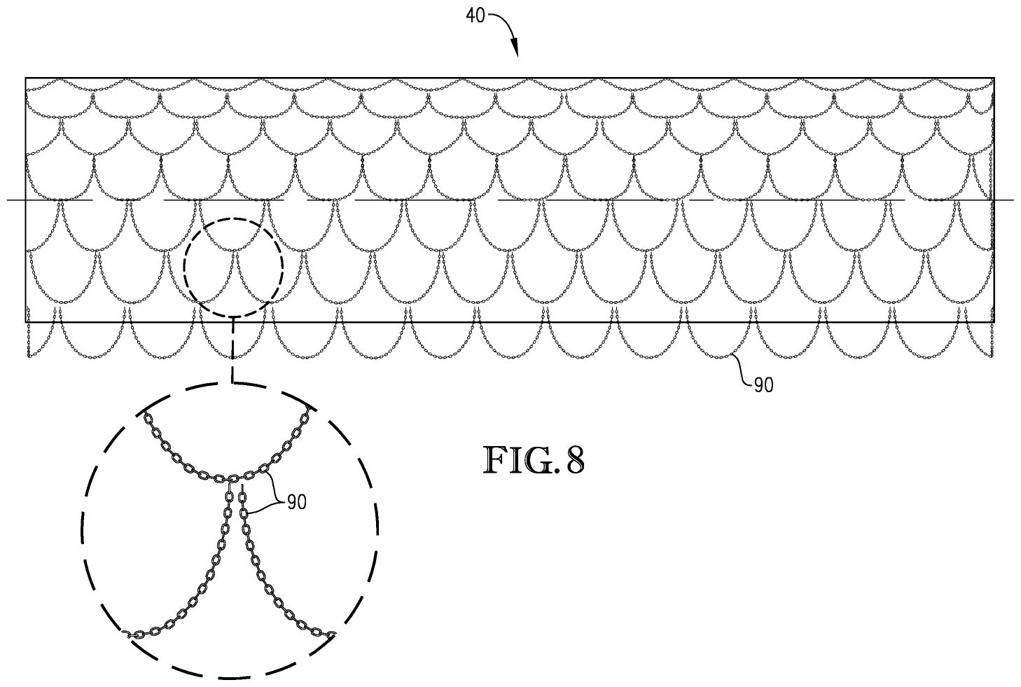

As shown in FIG. 7 and FIG. 8, in certain embodiments, chains 90 or other apparatus may be equipped to the one or more inner tubes 40 for removing buildup of the solid material 8 from the exterior surface of the inner tubes 40 or elsewhere within the interstitial space between tubes 40 and outer shell 20. As shown, the one or more chains 90 may be secured to the one or more inner tubes 40 and suspended therefrom, which are configured to scrape or otherwise dislodge build-up of material from the one or more inner tubes 40. As best shown in FIG. 7, the chains 90 are secured to the one or more inner tubes 40 such that rotation of calciner 10 causes the chains 90 to drape over the tubes 40 when on an upper portion of the rotation and hang from the inner tubes 40 when on a lower portion of the rotation. This feature advantageously allows for continuous cleaning of the surfaces within calciner 10, thereby maintaining high heat transfer efficiency. Although the embodiment shown depicts chains 90, other mechanisms may also be used that have similar functionality, such as knockers, cables, plates, etc.

### Alternative Embodiments

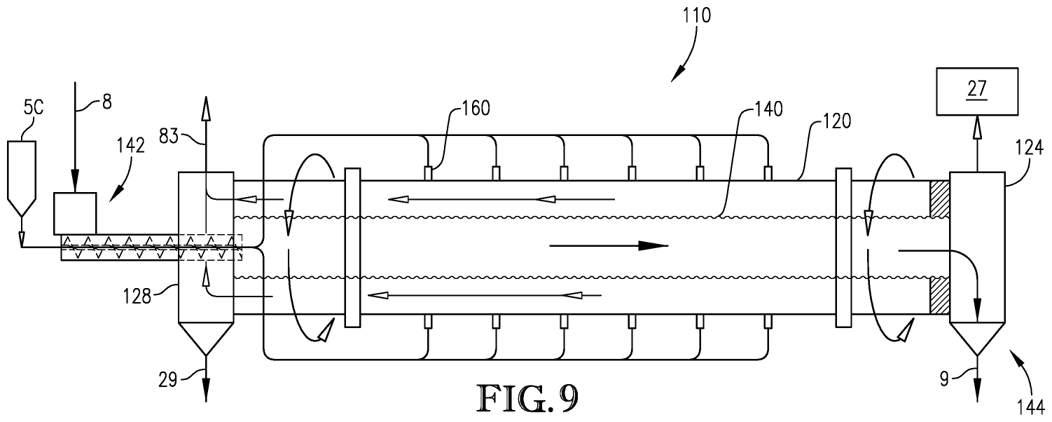

FIG. 9 to FIG. 16 depict an alternate embodiment of a rotary indirect calciner 110. Calciner 110 differs from calciner 10 depicted in FIG. 1 in that solid material 8 is passed through the one or more inner calciner tubes 140 and heated by indirect heat exchange with a heating fluid passing through the space between the outer shell 120 and the one or more inner tubes 140. The one or more inner tubes may generally comprise a feed material inlet 142 located at a first end of the outer shell 120 and a calcined material discharge outlet 144 located at a second end of the outer shell 120. In certain embodiments, the indirect calciner may operate such that the temperature within the one or more inner tubes 140 is about 900° C. to about 1100° C., or about 1000° C.

Calciner 110 may utilize a plurality of burners 160 oriented around the circumference of the outer shell 120. The burners 160 may be used to heat the annular or interstitial space between the shell (or shell liner) and the inner calciner tubes 140. Various types of burners can be utilized. However, in certain embodiments, flat flame burners are preferred. The burners can be forced air or self-aspirated. In certain embodiments, about 20 to about 100 burners are used, although even greater number of burners may be used if necessary or desired. Multifuel burners can also be used, depending on local fuel availability. Additional stationary burners can be oriented through the fixed hood of the discharge end, if necessary or desired. This is especially beneficial when waste heat sources are utilized.

For burner configurations using forced air, a blower air supply (not shown) may be required. This can be accomplished using a blower or fan with a radially configured air hood and manifold with branch air lines feeding each burner. This option provides combustion air from a stationary blower to the rotating shell mounted burners. Combustion air can also be preheated utilizing this method.

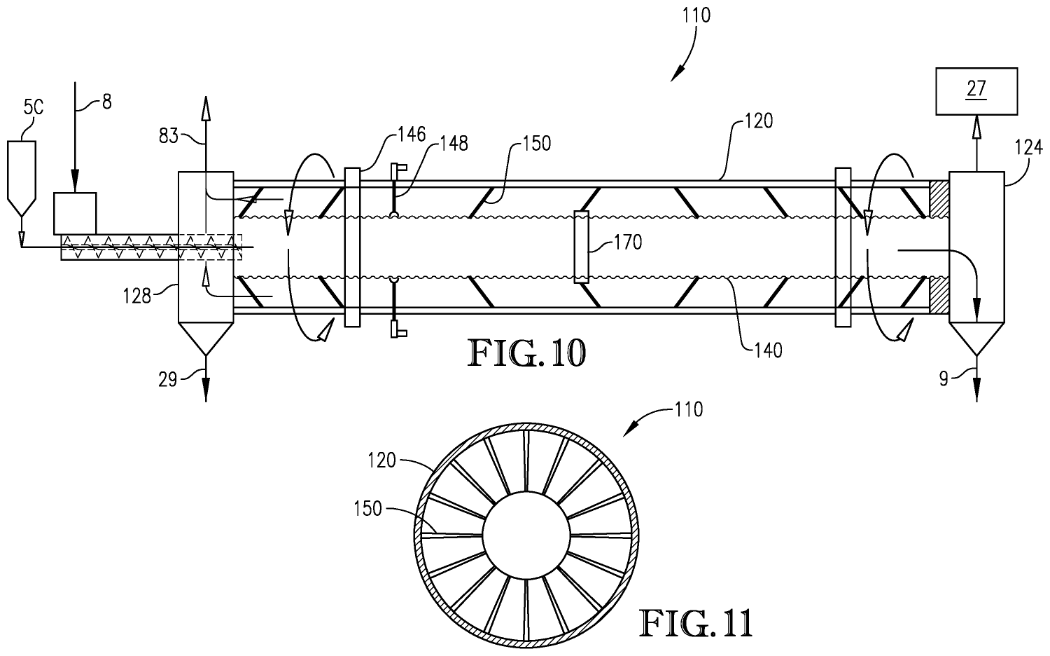

As illustrated in FIG. 10, the inner calciner tube(s) 140 of the calciner 110 can be uniquely supported with flat plates 150 (which may be made of a metal alloy material) arranged in an angled spoke configuration (see FIG. 11) to compensate for thermal expansion differences between the mounts 146, the calciner tube(s) 120, and the outer shell 140. These spokes 150 can be arrayed both radially and/or linearly with an angle of about 30 degrees or greater. As the space between the outer shell 120 and the inner calciner tube(s) 140 is heated to over 1000° C., the mounts thermally expand and, without design consideration, would impart stresses to the inner tube(s) 140 causing distortion and metal fatigue. The angled spokes 150 allow for thermal expansion in a more linear direction while still supporting the alloy tube loads. The angled spokes also mitigate the alloy tube diameter expansion by flexing to the expanded diameter. The spokes 150 can be welded or bolted to the respective surfaces. In addition, the spokes 150 can be attached to a cylindrical sleeve 170 surrounding and supporting the alloy tube for additional expansion allowance. Alternatively, or in conjunction with spoke supports, the inner calciner tube(s) 140 can be supported externally of the outer shell using constant spring supports 148 mounted to the external shell 120 that attach to the calciner tube(s) 140 through the outer shell 120 using rods (which may be made of a metal alloy material). The use of constant spring supports (a.k.a. spring cans) can maintain a steady constant load support throughout the full range of thermal expansion. These supports can be positioned perpendicular to the alloy tube(s) 140 or angled to help support and guide the expansion cycles. These options can be used to help provide somewhat of a baseline expansion “memory” for high cycle operations to ensure the expansion returns to intended starting positions upon cool down. Other effective variations and combinations for the alloy calciner tube(s) supports are feasible.

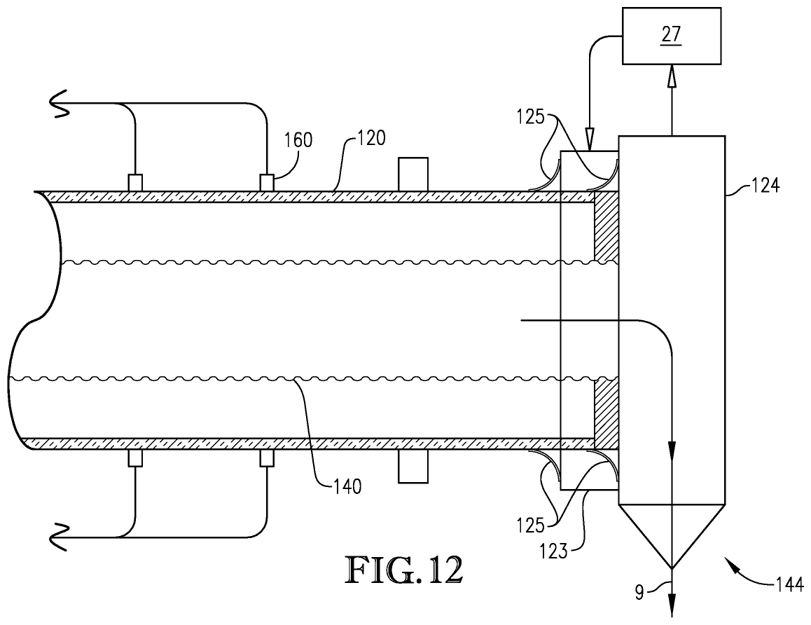

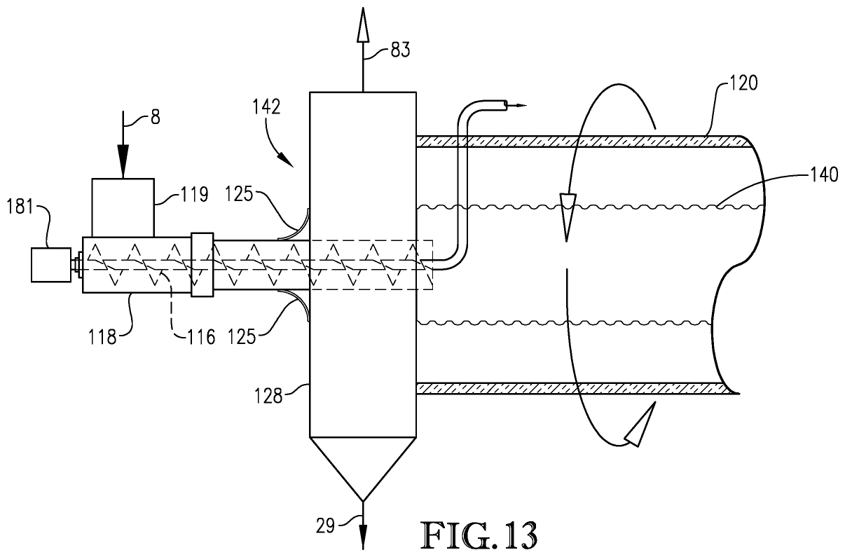

As best illustrated in FIG. 12 and FIG. 13, the ends of the outer shell 120 may be attached to enclosed hoods 124, 128 (or collars) with mechanical seals 125 to prevent leakage. The hoods 124, 128 are configured to separate and remove process gases 27 (such as CO2) from the center calciner tube(s) 140 and flue gases 83 from the heated zone between the inner calciner tube(s) 140 and outer shell 120. The end hoods 124, 128 may also be configured to collect and discharge calcined material 9 and particulates 29 exiting the calciner 110. These hoods 124, 128 and seals 125 have numerous configuration options. In certain preferred embodiments, two sets of mechanical seals may be used on the CO2 discharging end to further reduce the infiltration of ambient air and the subsequent dilution of the CO2 off-gases (See FIG. 12). The outermost seal 125 is sealed against an outer chamber 123 and the inner seal 125 is sealed against the end hood 124 of the calciner 110, leaving an enclosed space between the mechanical seals. Recirculated cooled CO2 gases may be injected as a purge gas into the enclosed space between the mechanical end seals to minimize CO2 dilution.

As best illustrated in FIG. 13, the material feed 8 to the inner calciner tube(s) 140 preferentially enters at a feed inlet 142 at a first end of the calciner 110. As shown, the feed inlet 142 of the tube may be entirely enclosed except for an opening for a feed auger 116 and auger tube 118. The auger 116 and auger tube 118 (or housing) may be permanently secured to the inner calciner tube end enclosure 128. In certain embodiments, the center feed auger 116 can rotate with the inner tube 140 and outer shell 120. The rotation provides the motive force required to feed material 8 into the calciner 110. The auger tube 118 may extend outside of the feed end hood 124 and can be sealed 125 against the hood 124 to minimize infiltration air. The rotating auger 116 and tube 118 can be connected to a sealed joint on the auger tube 118 to allow the screw to feed from a non-rotating hopper 119.

The feed end of the calciner tube(s) 140 may be closed or capped, and the heated annular space may be open on the feed end of the calciner 110 to exhaust hot gases 83. In certain embodiments, the discharge end of the calciner tube(s) 140 may be open to discharge calcined material 9 and CO2 gases 27. The heated annular space on the discharge end may be plugged or capped to prevent heated gases in the interstitial or annular space around the calciner tube(s) from diluting the CO2 off-gases.

Axial feed and discharging configurations (not shown) may also be used in accordance with embodiments of the present invention. These configurations would feed material through the outer shell 120 and funnel the material to the inner calciner tube(s) 140. Suitable axial hood configurations would be used to ensure a sufficiently tight seal to prevent dilution of CO2 gases when using axial feed and discharging methods.

To facilitate the supply of compressed gases such as natural gas, nitrogen, or compressed air, the feed auger shaft 116 can be designed to input gases using a rotary joint 181 on the end of the seal hollow shaft 116, as further illustrated in FIG. 13. The compressed gas can enter through the rotary joint 181 and travel through a passage in the auger shaft 116, where it can be manifolded and routed to the outer rotating shell 120 for distribution. Design considerations include piping wear guards or shrouds to prevent pipe wear from calcined feed material and to limit thermal exposure. Alternatively and/or additionally, a conventional auger with a solid shaft can be used and a conduit for the supply of compressed gas can be located at the outlet end of the indirect rotary calciner 110. The conduit can be rotatable with the outer shell 120 much like the auger shaft. Instead of delivering compressed gases to the indirect rotary calciner 110, the conduit and/or hollow auger shaft can be used to remove gases comprising a volatilized substance from the one or more calciner tubes 140.

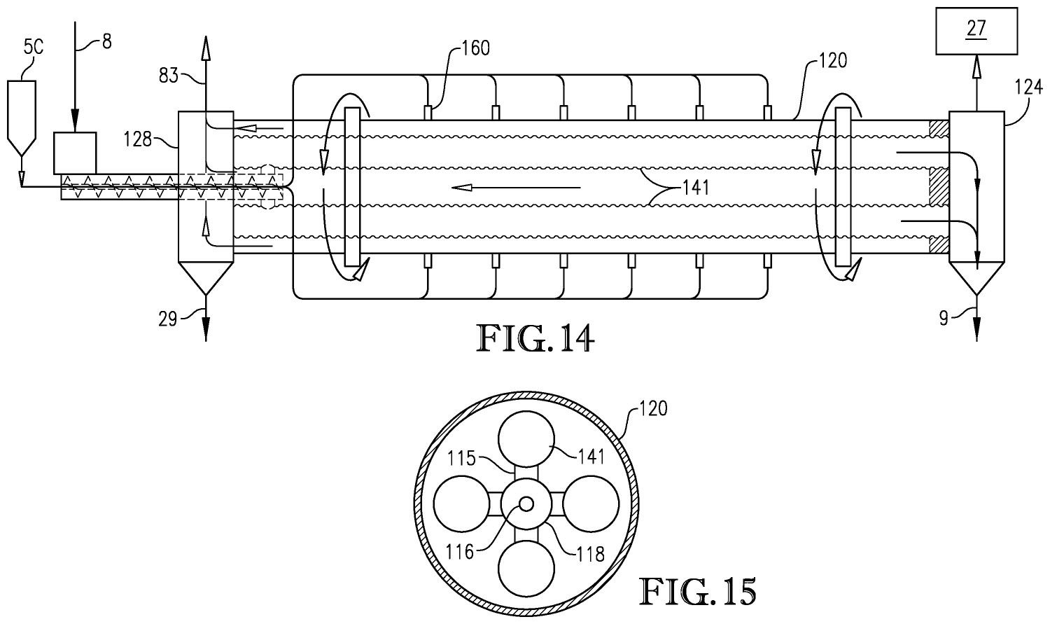

In certain embodiments, as illustrated in FIG. 14 and FIG. 15, the inner calciner tube(s) of the present invention can be configured as a set of multiple smaller tubes 141 arrayed around a center axis and supported in a similar manner described above. By way of example, a single three-meter diameter calciner tube that is 50 meters in length has an area of 474 m². A one-meter diameter calciner tube that is 50 meters long has a surface area of 157 m². Due to the smaller diameter of a one-meter calciner tube, it is possible to array at least four one-meter calciner tubes in the same cylindrical area occupied by a single three-meter alloy calciner tube. This example using a set of four tubes provides 628 m² of total surface area. Even greater surface areas can be achieved with different tube diameters and grouping configurations. Since surface area is a primary factor in the performance of indirect calciners, the ability to increase the available heat exchange surface area provides a significant advantage. Traditional methods are even more limited in their ability to span and support large multiple calciner tubes than single calciner tubes previously described. Therefore, embodiments of the present invention provide for yet another key improvement over existing indirect calcination methods.

Feeding multiple calciner tubes can utilize the same fixed feed auger 116 previously described with additional features. The feed auger pipe 118 may be connected to radially arranged enclosed chutes 115 which discharge into their respective tubes 141 when the calciner tube 141 is rotated in the down position. Each calciner tube feed end may be capped to prevent mixing of exiting hot interstitial exhaust gases and incoming feed material, and each calciner tube discharge may remain open to freely discharge the calcined material and CO2 gases. The interstitial space on the discharge end of the inner tubes is blocked or capped to prevent mixing of hot annular or interstitial space exhaust gases and evolved CO2.

Additionally, a calcined material collector and discharge auger can be employed along the center axis of the array of alloy calciner tubes. This center collection and discharging auger may connect each tube with a central auger by means of angled chutes. These chutes can be designed so that when the tube is in the upper position, the calcined material slides down the chute into the discharge screw auger. The opposite side of the chutes may be fitted with vertical plates to impede backflow of material when the tube is in the lower position.

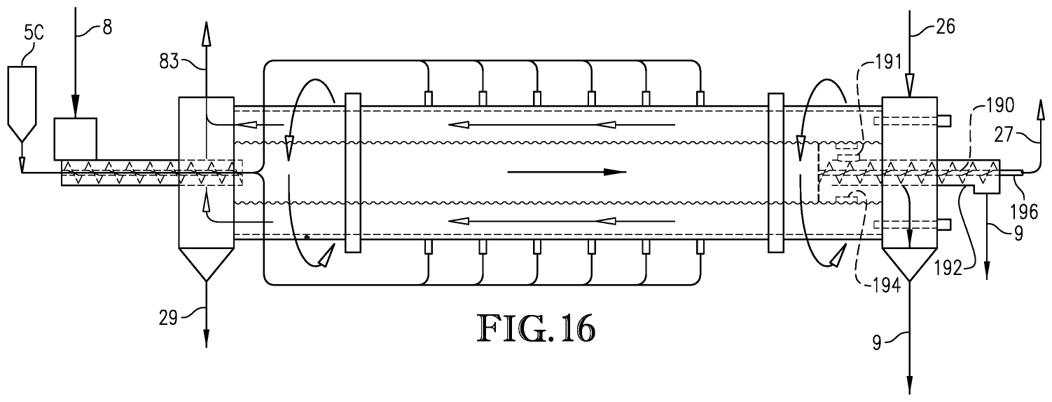

As best illustrated in FIG. 16, for single inner tube 140 operation with a center discharge auger 190, lifting flights 194 may be fitted on the interior end of the inner tube 140 to lift the calcined material and dump the material into the center discharge screw auger pipe 192 or scoop. In this configuration, the discharge auger 190 may be fixed to the tube 140 to rotate, while the discharge auger tube 192 is fixed to the non-rotating hood 124, so that the discharge auger fill hopper 191 or scoop remains in the upright position to receive material from the inner tube lifters 194.

In certain embodiments, a center discharge pipe 196 for CO2 off gases can be utilized in conjunction with a center discharge screw auger 190 in the present invention rather than (or in addition to) being vented using the end hood 124. This is particularly beneficial when the discharge hood 124 is needed to collect and discharge dust from dust ladened waste heat sources, which can be used as primary or supplemental heating of the annular or interstitial spaces around the calciner tube(s). Waste heat sources for heating the interstitial spaces around the alloy calciner tube(s) 140 can include hot gases exiting the rotary clinker kiln in cement manufacturing. Therefore, the use of a center discharging screw auger 190 and center CO2 venting pipe 196 increases the potential functionality of the present invention while preserving tight control and separation of the CO2 off-gases produced.

The power supply to the equipment mounted on the outer shell can be provided by electric contacting tracks on the rotating outer drum shell (not shown). These electrical tracks on the outer shell drum interface with ground mounted stationary electrical contacts. The power tracks may be covered with a stationary hood for protection. The power supply can be 120V single phase, 480 V 3-phase, or even 24 V DC. Small power requirements can be provided by shell mounted solar panels or a small generator mounted on the rotating shell and turning by interfacing with a stationary guard or housing.

### Methods

Methods in accordance with embodiments of the present provide for heat treatments of solid materials utilizing indirect rotary calciners, such as those described above. Exemplary methods include introducing a solid material into an indirect rotary calciner, where it undergoes calcination, pyrolysis, or other thermal treatment or thermal decomposition process.

In certain embodiments, the methods comprise a modification to the conventional cement or lime production process flow so as to integrate an indirect calcination stage between the suspension pre-heater and the rotary clinker kiln. In at least one embodiment, there is provided a method for producing cement or lime materials utilizing direct and indirect heating processes to isolate the thermal treatment temperature range, particularly where non-combustion related CO2 is evolved from the carbonaceous components of the raw material, including but not limited, to calcium carbonate (CaCO3). The effects of isolating the hot raw materials from direct process gas flows, specifically in the calcination range where CO2 is primarily evolved, allows the non-combustion dissociated CO2 to remain highly concentrated, thereby eliminating or significantly reducing the need for elaborate and expensive postproduction CO2 capture and concentration methods. In particular, CO2 capture over 50% is possible without postproduction capture technologies. For applications seeking higher CO2 capture percentages, postproduction capture technologies can be greatly reduced in size, complexity, and operating cost by employing indirect calcination as an integrated part of the overall process.

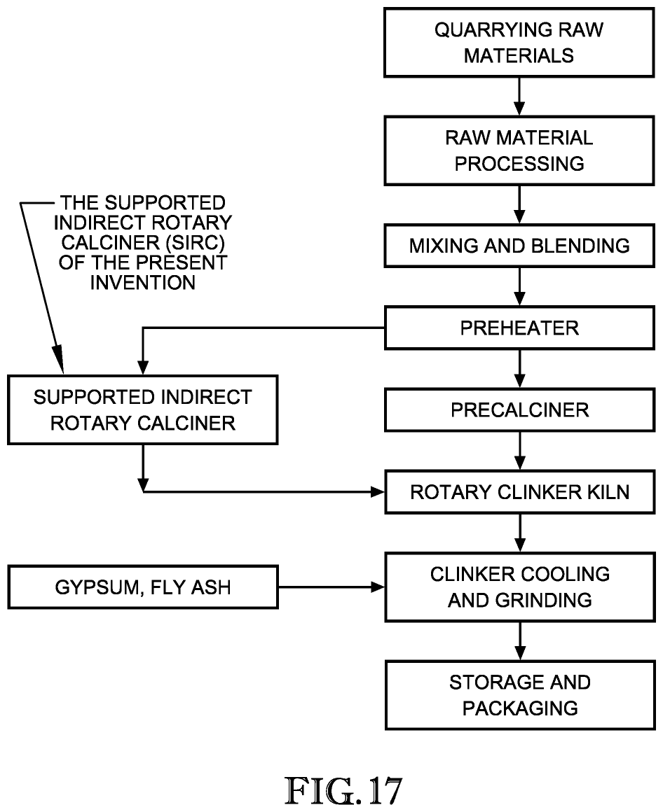

An exemplary process flow in accordance with embodiments of the present invention is illustrated in FIG. 17. Advantageously, in certain cement production embodiments, the thermal treatment portion of the cement production process alternates between direct and indirect material contact with hot process gases. Thus, these methods are particularly effective in concentrating and capturing a high percentage of the non-combustion associated CO2 emissions primarily resulting from the calcination of the CaCO3 fraction of the raw material.

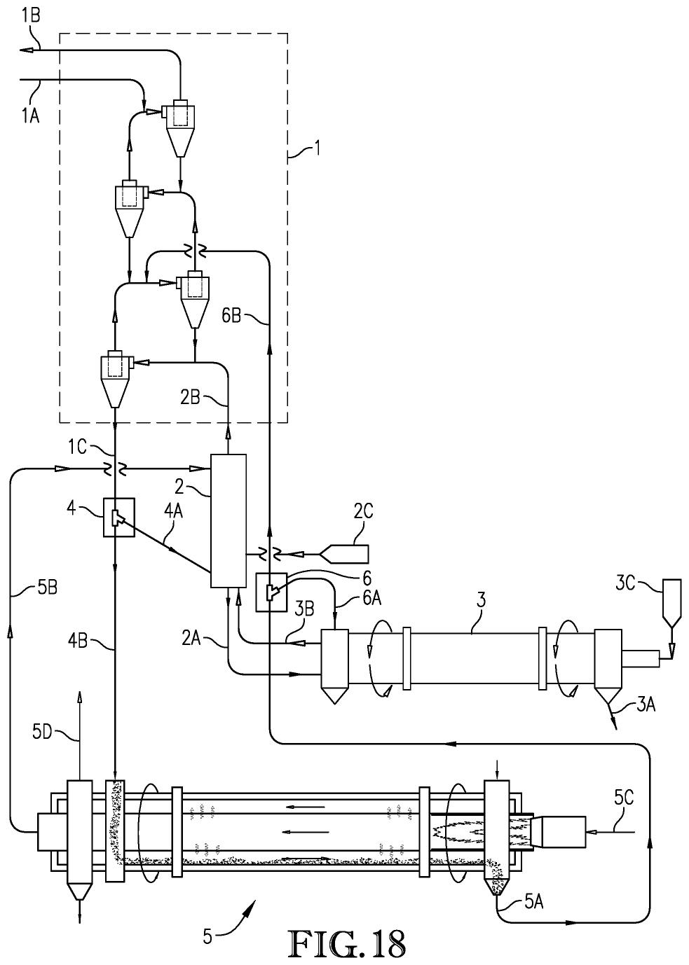

An exemplary process flow for cement production is illustrated in FIG. 18. As shown, the process begins with raw milled cement feed material, also known as raw meal 1A, which is fed to a preheating process 1. The preheating process 1 may comprise feeding the raw meal 1A at the top of a cascading suspension preheater tower and preheating the raw meal by direct contact with waste heat from processed gases 1B. The pre-heated raw meal material exits the pre-heating process 1 at about 700° C. to about 800° C.

Following pre-heating, for example in the suspension preheater, a pre-calciner 2 is traditionally used to pre-calcine the carbonaceous fraction of the raw meal prior to introduction to the rotary clinker kiln 3. A fuel gas 2C may be supplied to pre-calciner 2 to provide at least a portion of the necessary heat. Material traditionally exits the pre-calciner 2 at about 950° C. Following this pre-calciner 2, the pre-calcined material 2A would normally enter the rotary clinker kiln 3 for heat treatment at approximately 1450° C. to produce a clinker product 3A. A fuel gas 3C may be supplied to a burner used to provide heat to kiln 3. At least a portion of the waste heat 3B from kiln 3 may be directed to pre-calciner 2 to provide direct heating in the pre-calciner 2. At least a portion of the waste heat 2B from the pre-calciner 2 may be directed to the preheating process 1 to provide additional pre-heating energy.

As shown in FIG. 18, embodiments of the present invention modify the conventional process flow so as to eliminate the need for a pre-calciner 2, or to supplement the pre-calciner 2. The direct contact pre-calciner 2 is instead replaced with (or supplemented with) a rotary indirect calciner 10 in the process flow. The rotary indirect calciner 10 may be fed material 1C directly from the suspension preheating process 1 or via by-pass 4 to line 4B.) As described in greater detail below, the indirect rotary calciner 10 generally comprises elongated (e.g., cylindrical) rotatable outer shell and one or more inner tubes residing within the outer shell. The preheated material 1C or 4B fed to the calciner 10, wherein the calcine reaction occurs to release carbon from the material, thereby producing a calcined material 5A and a recoverable CO2 gas 5D. In certain embodiments, a fuel gas 5C can be supplied to calciner 10 for burners to provide at least a portion of the necessary heat for the calcine process.

Due to the raw cement meal being preheated prior to entering the indirect calciner 10, the calcining energy requirements are reduced significantly. For example, the energy input may be reduced to only what is required to calcine the calcium carbonate portion of the cement meal into calcium oxide and CO2 gas. Due to the indirect nature at this stage of the process, the CO2 gases remain highly concentrated and are therefore easier to capture for use or sequestration.

As shown in FIG. 18, in certain embodiments, the indirect rotary calciner 10 discharges calcined material 5A directly to the rotary clinker kiln 3 without cooling between stages. In certain embodiments, the calcined material 5A may have a temperature of about 900° C. to about 1100° C., or about 1000° C. In certain embodiments, at least a portion of the heated calcined material 5A may be recycled 6 back to the preheating process 1, which can improve energy efficiency. Additionally, when used in combination with a pre-calciner 2, at least a portion of the heating fluid 5B from the calciner 10 may be directed to pre-calciner 2 to provide direct heating in the pre-calciner 2. In addition, a portion of the heated calcined material 5A, particularly calcium oxide, can be recycled to the preheating process 1 for calcium looping purposes. Since the preheating process 1 can be configured to rely upon flue gas as a heat source, recycling calcium oxide to the preheating process can sorb at least some of the CO2 present in this gas and CaCO3 is reformed. Thus, additional quantities of CO2 from the preheating process 1 can be removed and added to the concentrated CO2 stream 5D from the rotary calciner 10.

By way of a reference example, the SIRC can be used in a cement production process and facility, new construction or retrofitted, using a dry process with preheater and pre-calciner operating with the following general operating parameters. The pre-calciner material operating temperature can be about 50° C. inlet temperature and upwards of about 800° C. exit temperature. The pre-calciner can operate at about 1000°° C. to achieve a 90% minimum calcination of the CaCO3 fraction of the raw feed material. The rotary clinker kiln can operate at a material temperature reaching about 1450° C. Overall traditional thermal energy requirements in terms of total fuel energy consumption can be about 3,300 KJ/kg clinker. The magnitude of CO2 generated can be about 0.80 to 0.85 kg CO2/kg clinker produced. It should be understood that although these operating conditions provide a reference example, the SIRC according to embodiments of the present invention may also be used in cement production processes and facilities having other operating conditions.

Infiltration air in the raw mills, preheaters, and rotary clinker kiln can occur further diluting the CO2 generated. The indirect calciner of the present invention minimizes air infiltration into the indirect calciner to preserve the concentration of the CO2 off-gases.

Embodiments of the present invention directed to cement production include, but are not limited to, the following key benefits:
1. Calcining is more uniform and therefore resulting in more uniform clinker production and higher quality.
2. The raw cement meal does not need to be ground as fine to achieve over 90% calcination.
3. The rotary clinker kiln production capacity is favorably increased, and the fuel requirements are decreased.
4. Feed material sources higher in alkalis and chlorides can be utilized to a greater extent.

Indirect calcination used in series with a suspension pre-heater has a very low energy penalty. The SIRC, when operated in an integrated manner within a cement production plant, minimizes the total fuel energy requirement by continuing to utilize waste heat from the rotary clinker kiln flue gases for cement raw meal preheating as occurs in the typical cement manufacturing process. Other indirect calcination concepts for CO2 capture in cement plants operate independently of the cement plant process flow and therefore suffer from excessive energy efficiency limitations. This significant reduces the overall CO2 reduction since additional fuel is required thereby offsetting some of the benefits of the CO2 captured.

Generally, there is a maximum carbon capture rate that can be achieved with indirect calcination, since only CO2 generated in the calciner can be captured. In at least one embodiment, the present invention is effective at removing up to 56% of the overall total CO2 emitted from cement or lime production processes.

In at least one embodiment, in applications where less than 40% CO2 capture is desirable or acceptable, it is possible to thermally treat only a portion of the overall raw material for producing cement and lime utilizing alternating direct and indirect thermal treatment of the present disclosure, thereby reducing the size and scale of the equipment required.

Embodiments of the present invention envision feeding the calciner with hot pre-heated material and discharging calcined material without cooling to preserve heat for further thermal treatment or to transfer to heat recovery equipment.

Although the indirect calcination process above describes an embodiment for CO2 capture from cement plants, it should be understood that other processes can benefit from the indirect rotary calciner according to embodiments of the present invention.

For example, in certain embodiments, the SIRC can be configured to provide for methods of pyrolysis of a carbonaceous material, and optional thermal oxidation of the resulting off-gases. In certain such embodiments, the organic material may be introduced into the SIRC and pyrolyzed at a temperature of at least 400° C., at least 600° C., at least 700° C., or at least 800° C. The pyrolysis reactions produce at least a quantity of thermally treated solid material and an off-gas, such as pyrolysis gas or synthesis gas (syngas). The solid material can be discharged from the SIRC and recovered as described herein. In certain embodiments, at least a portion of the hot off-gas can be directed into the heating tube and used to provide at least a portion of the heating for the pyrolysis process. In certain such embodiments, at least a portion of the off-gas can be thermally oxidized in a burner or hot heat transfer fluid to produce a treated waste gas stream. In certain embodiments, at least a portion of the waste gas stream may be used to pre-dry or pre-heat at least a portion of the feed material.

### Other Considerations

The systems, apparatuses, and methods according to preferred embodiments are described above. It is to be understood, however, that these features do not necessarily limit the overall scope of the invention. Additionally, it should be understood that these features may be included individually or in combination with one or more other features described herein in relation to one or more embodiments within the scope of the invention. Additional advantages of the various embodiments of the invention will be apparent to those skilled in the art upon review of the disclosure herein and the working examples below.

As used herein, the phrase “and/or,” when used in a list of two or more items, means that any one of the listed items can be employed by itself or any combination of two or more of the listed items can be employed. For example, if an apparatus is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

1. An indirect rotary calciner comprising:
an elongated rotatable outer shell; and
one or more inner tubes residing within the outer shell,
the one or more inner tubes being affixed to the outer shell such that the one or more inner tubes rotate upon rotation of the outer shell.

2. The calciner of claim 1, wherein the one or more inner tubes comprises a single inner tube concentric with the rotatable outer shell.

3. The calciner of claim 2, wherein the inner tube is positioned within the outer shell such that the inner tube and outer shell have the same center axis.

4. The calciner of claim 1, wherein the one or more inner tubes are affixed to the outer shell by a plurality of resilient supports so as to accommodate thermal expansion and contraction of the one or more inner tubes.

5. The calciner of claim 1, wherein the outer shell comprises an insulated interior wall.

6. The calciner of claim 6, wherein the insulated interior wall comprises a refractory liner.

7. An indirect rotary calciner comprising:
an elongated rotatable outer shell comprising a first end and a second end and configured to calcine a solid material passing therethrough;
one or more inner tubes residing within the outer shell configured to flow a heating fluid therethrough to heat the solid material passing through the outer shell; and
one or more support members interconnecting the rotatable outer shell and the one or more inner tubes.

8. The calciner of claim 7, wherein each of the one or more inner tubes extends at least the length of the outer shell.

9. The calciner of claim 7, further comprising a burner located at one end of the one or more inner tubes and configured to provide heat to at least a portion of the heating fluid flowing through the one or more inner tubes.

10. The calciner of claim 7, wherein the one or more support members comprises a plurality of resilient support members each tangentially connected to a single inner tube.

11. The calciner of claim 10, wherein the single inner tube comprises at least two tube segments connected by a support ring encircling adjacent ends of the at least two tube segments, wherein the one or more support members are secured to the support ring and extend therefrom toward the outer shell.

12. The calciner of claim 7, wherein the one or more support members each comprise a protective liner formed on at least a portion thereof and configured to protect the support members from damage by the solid material passing through the outer shell.

13. The calciner of claim 7, further comprising apparatus for removing buildup of the solids material from an exterior surface of the one or more inner tubes and/or an interior surface of the outer shell.

14. A method of thermally treating a solid material, the method comprising:
providing an indirect rotary calciner comprising:
an elongated rotatable outer shell, and
one or more inner tubes residing within the outer shell affixed to the outer shell such that the one or more inner tubes rotate upon rotation of the outer shell;
introducing a solid material into the indirect rotary calciner and producing a thermally treated material and a quantity of a volatilized substance; and
recovering at least a portion of the quantity of the volatilized substance produced in the indirect rotary calciner.

15. The method of claim 14, wherein the solid material is a carbonaceous material, and the volatilized substance comprises CO2.

16. The method of claim 14, wherein the solids material is a preheated raw material, wherein the thermally treated material is a calcined material, and the volatilized substance is CO2, the method further comprising introducing at least a portion of the calcined raw material into a kiln to produce a clinker product.

17. The method of claim 16, wherein the method further comprises directing a portion of the calcined raw material to the preheater apparatus and using the portion of the calcined raw material to sorb CO2 within the preheater apparatus.

18. The method of claim 14, wherein the solid material comprises a quantity of organic material, wherein at least a portion of the quantity of organic material is introduced into the outer shell of the indirect rotary calciner and pyrolyzed, thereby producing at least a quantity of the thermally treated raw material and an off-gas as the volatilized substance, the method further comprising introducing the off-gas into the one or more inner tubes and thermally oxidizing at least a portion of the off-gas therein to produce a treated waste gas stream.

19. The method of claim 18, further comprising pre-drying at least a portion of the quantity of organic material using at least a portion of the treated waste gas stream before introducing the organic material into the indirect rotary calciner.

20. The method of claim 14, wherein the solid material is introduced into the outer shell and is thermally treated by indirect heat transfer from a heating fluid flowing through the one or more inner tubes.
